(19) United States
(12) Patent Application Publication
(10) Pub. No.: US 2004/0173424 A1
(43) Pub. Date: Sep. 9, 2004

(54) Internal damper valving filter

(75) Inventors: John R. Briar, Dayton, OH (US); Michael D. Clark, Dayton, OH (US); Essam E. Salama, West Chester, OH (US)

Correspondence Address: SCOTT A. MCBAIN, DELPHI TECHNOLOGIES, INC., Legal Staff, Mail Code: 480-410-202, P.O. BOX 5052, Troy, MI, 48007, US

(73) Assignee: DELPHI TECHNOLOGIES INC.

(21) Appl. No.: 10/378,223

(22) Filed: Mar. 3, 2003

(51) Int. Cl. F16F 9/34

(52) U.S. Cl. 188/322.14

(57) ABSTRACT

A vehicle suspension damper with integrated hydraulic fluid filter. A vehicle suspension damper assembly is provided. A damper containing hydraulic fluid and a filter screen internal to the suspension damper are provided. Hydraulic fluid in the damper is filtered by the internal filter during operation of the suspension damper assembly. A vehicle including a vehicle suspension damper assembly with internal hydraulic fluid filtration is also provided.

### TECHNICAL FIELD OF THE INVENTION

This invention relates to vehicle damper systems, and more particularly to provisions for improved performance of vehicle dampers.

### BACKGROUND OF THE INVENTION

Vehicles such as automobiles, trucks, buses, motor homes, and motorcycles typically include a suspension system including dampers. Suspension system dampers include, for example, various hydraulic dampers, solenoid or actuator-controlled, adjustable dampers, and coil-over spring dampers. Hydraulic dampers such as shock absorbers and struts are quite common for use as vehicle suspension dampers. Generally, a hydraulic damper assembly has a fluid reservoir and valves that operate together to provide a hydraulic damping function. Damper valving is sensitive to and can be affected by internal contamination from manufacturing by-products such as weld balls and metal slivers. Such contaminants can be drawn into the damper base valve with fluid intake during a damper rebound stroke, and then become lodged in the valve. A trapped particle creates a leak path in the valve and potentially a noise condition due to valving disc resonance, which is detected on the vehicle as an objectionable damper squeaking noise. Therefore, it would be desirable to provide an improved damper assembly that overcomes these and other disadvantages.

### SUMMARY OF THE INVENTION

In accordance with the invention, a vehicle suspension damper assembly is provided. A damper containing hydraulic fluid and a filter screen internal to the suspension damper are provided. Hydraulic fluid is filtered by the internal filter during operation of the suspension damper assembly.

According to another feature of the invention, a vehicle including a vehicle suspension damper assembly is provided. A damper containing hydraulic fluid and a filter internal to the damper are provided. Hydraulic fluid is filtered during operation of the damper assembly.

The foregoing and other features and advantages of our invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is an illustration of a strut with an internal hydraulic fluid filter in accordance with the invention.

FIG. 2 is a top view illustration of a hydraulic fluid filter screen in accordance with the invention.

FIG. 3 is a side view illustration of the hydraulic fluid filter screen of FIG. 3.

FIG. 4 is an illustration of a shock absorber with an internal hydraulic fluid filter in accordance with the invention.

### DETAILED DESCRIPTION OF THE PRESENTLY PREFERRED EMBODIMENTS

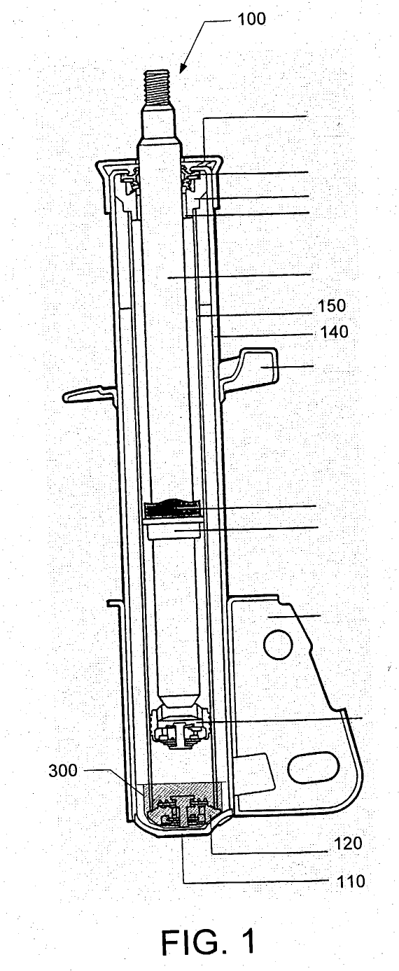

FIG. 1 is an illustration of a strut with an internal hydraulic fluid filter in accordance with the invention. FIG. 1 shows a strut assembly 100. As shown in FIG. 1, the strut assembly 100 comprises a cylinder tube 150 assembly including a base valve 120, a reservoir tube 140, a base cup 110, and a hydraulic fluid filter 300. The strut assembly 100 incorporates other components that will be recognized by skilled practitioners but are not relevant to the present discussion.

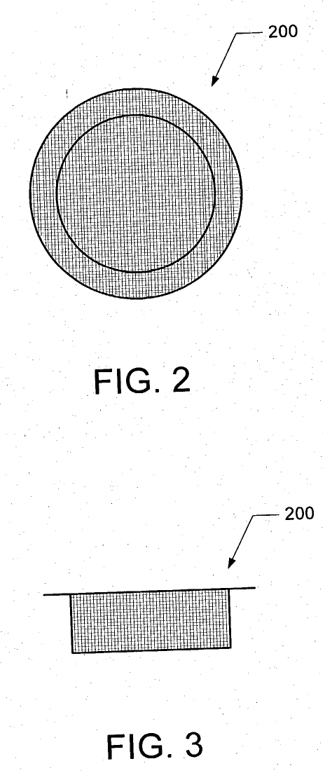

FIG. 2 shows a top view of a hydraulic fluid filter screen 200 such as may be used in the present embodiment. The hydraulic fluid filter screen 200 (hereinafter “filter”) is generally a mesh screen suitable for filtering a hydraulic fluid. FIG. 3 shows a side view of the filter 200 of FIG. 2. The filter 200 is generally a metallic wire mesh, but may also be fabricated with a non-metallic material such as a thermoplastic, a porous organic cloth material, or another suitable material. Typically, the filter 200 is formed of about 500 micrometer to 900 micrometer mesh. The mesh gauge is selected based on the size and shape of potential contaminant particles, such as weld balls, and so that no flow restriction occurs under high-velocity damping events or low temperature operation.

The filter 200 may be formed in any shape suitable for positioning between the base cup 110 and the base valve 120 and around the outside of the cylinder tube 150. Generally, the filter 200 is formed and sized such that it assembles as a single piece over the cylinder tube 150 and base valve 120, and remains attached to the cylinder tube 150 as it is inserted into the reservoir tube 140 during construction of the strut assembly 100. Additionally, the filter 200 shape may be selected for ease of manufacture, fit and retention during damper assembly.

Modification of existing strut components such as the cylinder tube 150, reservoir tube 140, base valve 120 and base cup 110 are not required to utilize the filter 200. Once the filter 200 is positioned in the strut assembly 100 during manufacture, it is restrained in position between the base valve 120 and the base cup 110 for the life of the strut assembly 100.

In operation, hydraulic fluid in the reservoir tube 140 is filtered by the filter 200 during a rebound stroke as hydraulic fluid is drawn through the base valve from the reservoir tube 140 into the cylinder tube 150. Any contaminants that may be suspended in the hydraulic fluid or collected between the base cup 110 and the base valve 120 are prevented from being drawn into the base valve 120 by the filter 200.

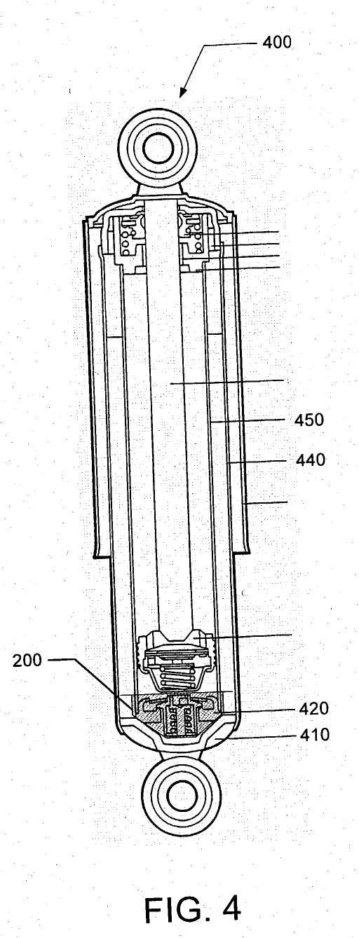

FIG. 4 is an illustration of a shock absorber with an internal hydraulic fluid filter in accordance with the invention. FIG. 2 shows a shock absorber assembly 400. As shown in FIG. 2, the shock absorber assembly 400 comprises a cylinder tube 450 assembly including a base valve 420, a reservoir tube 440, a base cup 410, and a hydraulic fluid filter 200 as described in reference to FIGS. 1, 2 and 3. The shock absorber assembly 200 incorporates other components that will be recognized by skilled practitioners but are not relevant to the present discussion.

As described with reference to FIGS. 1, 2 and 3, the filter 200 may be formed in any shape suitable for positioning between the base cup 410 and the base valve 420 and around the outside of the cylinder tube 450. Generally, the filter is formed and sized such that it assembles as a single piece over the cylinder tube 450 and base valve 420, and remains attached to the cylinder tube 450 as it is inserted into the reservoir tube 440 during construction of the shock absorber assembly 400. Additionally, the filter 200 shape may be selected for ease of manufacture, fit and retention during assembly. Modification of existing shock absorber components such as the cylinder tube 450, reservoir tube 440, base valve 420 and base cup 410 is not required to utilize the filter 200. Once the filter 200 is positioned in the shock absorber assembly 400 during manufacture, it is restrained in position between the base valve 420 and the base cup 410 for the life of the shock absorber assembly 400.

In operation, hydraulic fluid in the reservoir tube 440 is filtered by the filter 200 during rebound stroke as hydraulic fluid is drawn through the base valve from the reservoir tube 440 into the cylinder tube 450. Any contaminants that may be suspended in the hydraulic fluid or collected between the base cup 410 and the base valve 420 are prevented from being drawn into the base valve 420 by the filter 200.

The scope of the invention is indicated in the appended claims. We intend that all changes or modifications within the meaning and range of equivalents are embraced by the claims.

We claim:

1. A vehicle suspension damper assembly comprising:
a damper containing hydraulic fluid; and
a filter screen internal to the damper wherein the hydraulic fluid is filtered during operation of the damper assembly.

2. The apparatus of claim 1 wherein the suspension damper assembly includes a cylinder tube assembly having a base valve at a base end and wherein the filter is positioned around the cylinder tube base end between the base valve and the base cup of the damper.

3. The apparatus of claim 2 wherein the filter screen mesh is metallic.

4. The apparatus of claim 3 wherein the filter screen has a mesh size of about 500 to 900 micrometers.

5. The apparatus of claim 2 wherein the filter screen is non-metallic.

6. The apparatus of claim 5 wherein the filter screen has a mesh size of about 500 to 900 micrometers.

7. The apparatus of claim 1 wherein the suspension damper is selected from the group consisting of a shock absorber, a strut, and a solenoid or actuator-controlled, adjustable damper.

8. A vehicle including:
a vehicle suspension damper assembly comprising:
a damper containing hydraulic fluid; and
a filter internal to the damper wherein the hydraulic fluid is filtered during operation of the damper assembly.

9. The vehicle of claim 7 wherein the hydraulic damper assembly includes a cylinder tube assembly having a base valve at a base end and wherein the filter is positioned around the cylinder tube base end between the base valve and the base cup of the damper.

10. The vehicle of claim 8 wherein the screen mesh is metallic.

11. The vehicle of claim 8 wherein the screen has a mesh size of about 500 to 900 micrometers.

12. The vehicle of claim 10 wherein the screen is non-metallic.

13. The vehicle of claim 11 wherein the screen has a mesh size of about 500 to 900 micrometers.

14. The vehicle of claim 8 wherein the hydraulic damper is selected from the group consisting of a shock absorber, a strut, and a solenoid or actuator-controlled, adjustable damper.

15. A filtered hydraulic damper assembly comprising:
a hydraulic damper containing hydraulic fluid; and
filter means internal to the hydraulic damper wherein the hydraulic fluid is filtered during operation of the hydraulic damper.
